(19) United States
(12) Patent Application Publication
(10) Pub. No.: US 2023/0214751 A1
(43) Pub. Date: Jul. 6, 2023

(54) WORKFLOW MANAGEMENT WITH NO CODE MULTIEXPERIENCE PREDICTIVE WORKFLOW TASKS

(71) Applicant: SAP SE, Walldorf (DE)

(72) Inventors: Qiu Shi Wang, Singapore (SG); Lin Cao, Singapore (SG)

(21) Appl. No.: 17/646,890

(22) Filed: Jan. 4, 2022

(51) Int. Cl. G06Q 10/06; G06N 5/04; G06T 11/20

(52) U.S. Cl. CPC G06Q 10/0633; G06Q 10/06375; G06N 5/045; G06T 11/206

(57) ABSTRACT

Methods, systems, and computer-readable storage media for extracting, by a multi-experience runtime engine and from a metadata file, metadata that is descriptive of an analytics UI for display on a display of a computing device, the metadata including instructions for a binding to a service providing inference using one or more ML models, in response to the binding, transmitting an inference request to the service through a predictive data adapter, the inference request including data representative of a workflow task that is to be executed in a digital workplace, receiving inference results that are responsive to the inference request, and displaying, within the analytics UI, the inference results and at least a portion of the data representative of the workflow task.

### BACKGROUND

An enterprise can execute operations using software systems. In some examples, multiple software systems provide respective functionality. Accordingly, agents of the enterprise (e.g., employees) interface with enterprise operations through a so-called digital workplace. A digital workplace can be described as a central interface, through which a user (e.g., agent, employee) can access all of the digital applications required to perform respective tasks in operations of the enterprise.

In the digital workplace, users interact with computer-executed applications to perform a multitude of tasks. For example, in an enterprise setting, users can interact with one or more of an enterprise resource planning (ERP) application, a customer relationship management (CRM) application, and a human capital management (HCM) application to perform tasks in support of operations of an enterprise. To facilitate these interactions, applications are programmed with user interfaces (Uls), which include UI elements. Users interact with the application by providing input to and receiving output from UI elements. Example UI elements can include object pages, list pages, and analytics pages.

In executing operations, users execute a series of tasks (actions) as part of a workflow, which requires access to several different applications. Further, within each application, users need the correct page, menu items, and/or UI controls, for example, to perform a given task. A workflow task can be described as a content item that can be executed through a UI for different personae to view, edit, and take corresponding actions for the item. For example, in a capital expenditure (CapEx) workflow, respective Uls enable a requester (user) to input details of and submit a CapEx request for approval, and an approver (user) to review the details and approve/reject the request.

Workflow management enables enterprises to digitize workflows, manage decisions, and gain end-to-end process visibility, and can be considered a core technology of enterprise digitalization. Currently available workflow management technologies have limited capabilities. For example, such technologies can only list and display the existing and obvious data of a task (e.g., expenditure cost, operational cost, investment reason, requesting department). As such, and with reference to the above example, it is difficult for the approver to even acquire holistic information on the item, let alone understand the impact of the approval/rejection on other metrics of the enterprise (e.g., revenue, profit margin, sustainability, governance risk, and compliance).

### SUMMARY

Implementations of the present disclosure are directed to a predictive workflow and analytics platform. More particularly, implementations of the present disclosure are directed to a predictive workflow and analytics platform that integrates one or more machine learning (ML) models with an analytics user interface (UI) into a workflow task.

In some implementations, actions include extracting, by a multi-experience runtime engine and from a metadata file, metadata that is descriptive of an analytics UI for display on a display of a computing device, the metadata including instructions for a binding to a service providing inference using one or more ML models, in response to the binding, transmitting an inference request to the service through a predictive data adapter, the inference request including data representative of a workflow task that is to be executed in a digital workplace, receiving inference results that are responsive to the inference request, and displaying, within the analytics UI, the inference results and at least a portion of the data representative of the workflow task. Other implementations of this aspect include corresponding systems, apparatus, and computer programs, configured to perform the actions of the methods, encoded on computer storage devices.

These and other implementations can each optionally include one or more of the following features: actions further include automatically providing at least a portion of the metadata by an application studio in response to one or more selections of a developer interacting with the application studio; at least a portion of the metadata includes user input to an application studio that generates the metadata file; the metadata file is partially generated by developer selection of a template from a set of templates; the service is bound to the metadata file through user selection of one or more of the service and the ML model from a set of ML models within an application studio that generates the metadata file; the analytics UI is integrated into a workflow tasks UI that enables the user to execute a respective workflow task; and the multi-experience runtime engine extracts the metadata from the metadata file to render the analytics UI native to an operating system of the computing device.

The present disclosure also provides a computer-readable storage medium coupled to one or more processors and having instructions stored thereon which, when executed by the one or more processors, cause the one or more processors to perform operations in accordance with implementations of the methods provided herein.

The present disclosure further provides a system for implementing the methods provided herein. The system includes one or more processors, and a computer-readable storage medium coupled to the one or more processors having instructions stored thereon which, when executed by the one or more processors, cause the one or more processors to perform operations in accordance with implementations of the methods provided herein.

It is appreciated that methods in accordance with the present disclosure can include any combination of the aspects and features described herein. That is, methods in accordance with the present disclosure are not limited to the combinations of aspects and features specifically described herein, but also include any combination of the aspects and features provided.

The details of one or more implementations of the present disclosure are set forth in the accompanying drawings and the description below. Other features and advantages of the present disclosure will be apparent from the description and drawings, and from the claims.

### DESCRIPTION OF DRAWINGS

FIG. 1 depicts an example architecture that can be used to execute implementations of the present disclosure.

FIG. 2 depicts an example architecture in accordance with implementations of the present disclosure.

FIG. 3 depicts an example analytics user interface (UI) that can be provided in accordance with implementations of the present disclosure.

FIG. 4 depicts another example workflow task UI that can be provided in accordance with implementations of the present disclosure.

FIG. 5 depicts an example process that can be executed in accordance with implementations of the present disclosure.

FIG. 6 is a schematic illustration of example computer systems that can be used to execute implementations of the present disclosure.

Like reference symbols in the various drawings indicate like elements.

### DETAILED DESCRIPTION

Implementations of the present disclosure are directed to a predictive workflow and analytics platform. More particularly, implementations of the present disclosure are directed to a predictive workflow and analytics platform that integrates one or more machine learning (ML) models with an analytics user interface (UI) into a workflow task. Implementations can include actions of extracting, by a multi-experience runtime engine and from a metadata file, metadata that is descriptive of an analytics UI for display on a display of a computing device, the metadata including instructions for a binding to a service providing inference using one or more ML models, in response to the binding, transmitting an inference request to the service through a predictive data adapter, the inference request including data representative of a workflow task that is to be executed in a digital workplace, receiving inference results that are responsive to the inference request, and displaying, within the analytics UI, the inference results and at least a portion of the data representative of the workflow task. Other implementations of this aspect include corresponding systems, apparatus, and computer programs, configured to perform the actions of the methods, encoded on computer storage devices.

To provide further context for implementations of the present disclosure, and as introduced above, in executing operations, users execute a series of tasks (actions) as part of a workflow, which requires access to several different applications. Further, within each application, users need the correct page, menu items, and/or UI controls, for example, to perform a given task. A workflow task can be described as a content item that can be executed through a UI for different personae to view, edit, and take corresponding actions for the item. For example, in a capital expenditure (CapEx) workflow, respective UIs enable a requester (user) to input details of and submit a CapEx request for approval, and an approver (user) to review the details and approve/reject the request.

Workflow management enables enterprises to digitize workflows, manage decisions, and gain end-to-end process visibility, and can be considered a core technology of enterprise digitalization. Currently available workflow management technologies have limited capabilities. For example, such technologies can only list and display the existing and obvious data of a task (e.g., expenditure cost, operational cost, investment reason, requesting department). As such, and with reference to the above example, it is difficult for the approver to even acquire holistic information on the item, let alone understand the impact of the approval/rejection on other metrics of the enterprise (e.g., revenue, profit margin, sustainability, governance risk, and compliance). That is, there is a gap between the data provided as input to a workflow task and a result of executing the workflow task, if the workflow task were to be executed.

In view of the above context, implementations of the present disclosure are directed to a predictive workflow and analytics platform. More particularly, implementations of the present disclosure are directed to a predictive workflow and analytics platform that integrates one or more ML models with an analytics UI control into workflow tasks. Implementations of the present disclosure can be described as an intelligent workflow task technology that collects data that may be related to one or more workflow tasks from various backend data sources and analyzes the data with ML models to provide inferences that represent predicted outcomes and/or impacts of the one or more workflow tasks.

As described herein, implementations of the present disclosure also provide low-code/no-code integration of ML models with an analytics UI control into workflow tasks. As used herein, the terms low-code and no-code generally refer to software development platforms and/or tools that are targeted at users with little or no development experience (e.g., referred to as citizen developers, or low-code (no-code) developers). Another target of such platforms and/or tools can include more experienced developers having shorter timeframes for development (e.g., low-code (no-code) enabling developers to develop more quickly). Here, low-code can refer to development requiring some level of coding experience, while no-code can refer to development with no coding experience. While the present disclosure references low-code developers and/or no-code developers, it is appreciated that implementations of the present disclosure can be realized for the benefit of more sophisticated developers and/or developers having more generous timeframes to develop application extensions.

In some implementations, the predictive workflow and analytics platform of the present disclosure includes design-time components in an application studio and workflow task runtime components on multi-experience platforms. In general, runtime refers to execution of workflow management and design-time refers to design of workflow management before execution. As used herein, multi-experience platforms refer to disparate devices and/or operating systems (OSs) that users use to execute workflow tasks through UIs. For example, one user can use a tablet computing device that is operated using a first OS, while another user can use a smartphone that is operated using a second OS. Implementations of the present disclosure enable the UIs to be presented in a manner that is consistent with the respective OSs and devices (e.g., in terms of input elements, look, display size, etc. that are native to the device/OS).

In some implementations, and as described in further detail herein, a multi-experience runtime engine renders analytics UIs based on metadata that is generated by the design-time components. In some examples, the analytics UIs bind with predictive data provided from data intelligent services through a predictive data adapter. As described in further detail herein, this provides users native interactive experience on different devices with various form factors through multiple touch points. Further, the design-time components running in the application studio enable developers with low-code/no-code development experience to design analytics UIs, monitor the training of ML models and test the integration of ML models and analytics UIs. The output of the design-time components is the metadata that is deployed for runtime to provide analytics UIs on user devices.

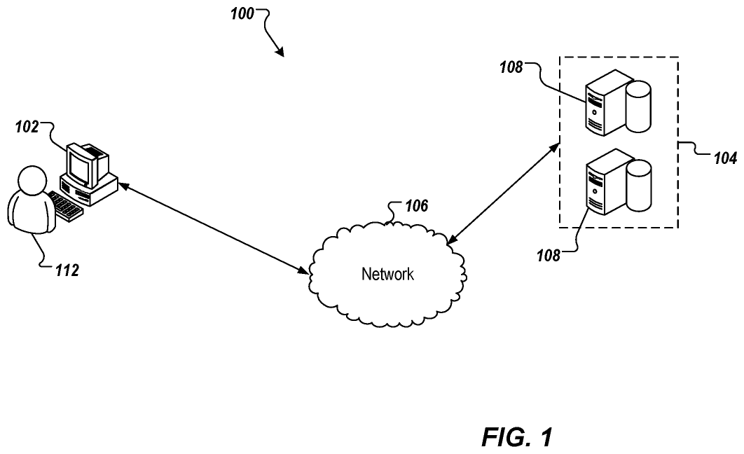

FIG. 1 depicts an example architecture 100 in accordance with implementations of the present disclosure. In the depicted example, the example architecture 100 includes a client device 102, a network 106, and a server system 104. The server system 104 includes one or more server devices and databases 108 (e.g., processors, memory). In the depicted example, a user 112 interacts with the client device 102.

In some examples, the client device 102 can communicate with the server system 104 over the network 106. In some examples, the client device 102 includes any appropriate type of computing device such as a desktop computer, a laptop computer, a handheld computer, a tablet computer, a personal digital assistant (PDA), a cellular telephone, a network appliance, a camera, a smart phone, an enhanced general packet radio service (EGPRS) mobile phone, a media player, a navigation device, an email device, a game console, or an appropriate combination of any two or more of these devices or other data processing devices. In some implementations, the network 106 can include a large computer network, such as a local area network (LAN), a wide area network (WAN), the Internet, a cellular network, a telephone network (e.g., PSTN) or an appropriate combination thereof connecting any number of communication devices, mobile computing devices, fixed computing devices and server systems.

In some implementations, the server system 104 includes at least one server and at least one data store. In the example of FIG. 1, the server system 104 is intended to represent various forms of servers including, but not limited to a web server, an application server, a proxy server, a network server, and/or a server pool. In general, server systems accept requests for application services and provides such services to any number of client devices (e.g., the client device 102 over the network 106).

In accordance with implementations of the present disclosure, and as noted above, the server system 104 can host a predictive workflow and analytics platform. For example, the user 112 interacts with a digital workplace through one or more Uls displayed on the computing device 102. In some implementations, the predictive workflow and analytics platform generates the one or more analytics Uls that are displayed to the user 112 on the computing device 102.

In some examples, the server system 104 hosts an application studio having design-time components that enable developers with low-code/no-code development experience to design analytics Uls, monitor the training of ML models and test the integration of ML models and analytics UIs. The output of the design-time components is the metadata that is deployed for runtime to provide the one or more analytics UIs on user devices, such as the client device 102. In some examples, the server system 104 (or another server system) hosts data intelligent services that provide inference results (prediction data) for consumption during runtime. During runtime, for example, the inference results can be provided from the data intelligent services for display in an analytics UI. For example, and as described in further detail herein, one or more analytics UIs can be generated based on metadata provided from design-time. In some examples, the metadata provides a binding to one or more ML models executed by the data intelligent services, which enables inference results to be received from the one or more ML models. The inference results are displayed within the one or more analytics Uls.

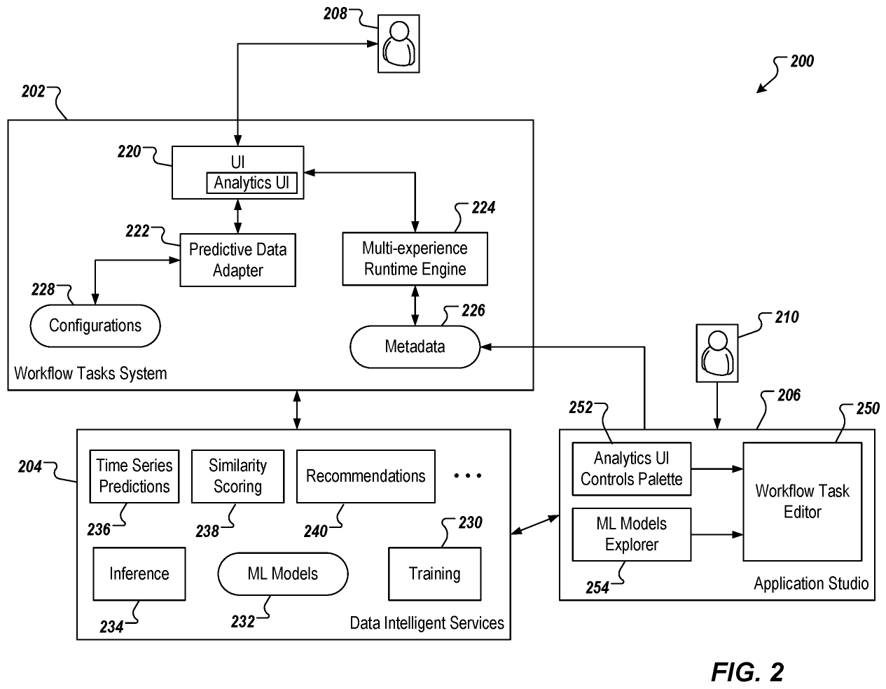

FIG. 2 depicts an example architecture 200 in accordance with implementations of the present disclosure. In the depicted example, the example architecture 200 includes a workflow tasks system 202, data intelligent services 204, and an application studio 206. As described in further detail herein, during runtime, a user 208 interacts with one or more Uls that can include one or more analytics Uls, provisioned in accordance with implementations of the present disclosure, to execute one or more tasks as part of a workflow. In some examples, the workflow tasks system 202 is installed and is executed on a computing device that the user 208 is using. In this manner, the workflow tasks system 202 is specific to the computing device and the OS executed thereon to provide a native user experience, as described herein. During design-time, a developer 210 (e.g., low code/no code developer) interacts with the application studio 206 to define the one or more analytics Uls that are available to users at runtime. In some examples, and as described in further detail herein, the one or more analytics Uls are integrated into one or more UIs that are used to execute workflow tasks.

In the example of FIG. 2, the workflow tasks system 202 includes a UI module 220, a predictive data adapter 222, a multi-experience runtime engine 224, a metadata store 226, and a configurations store 228. The data intelligent services 204 include a training service 230, a ML models store 232, an inference service 234, a time series predictions service 236, a similarity scoring service 238, and a recommendations service 240. It is contemplated that the data intelligent services 204 can include any appropriate service, such as, for example, any service that leverages one or more ML models. The application studio 206 includes a workflow task editor 250, an analytics UI controls palette 252, and a ML models explorer 254.

During design-time, the developer 210 interacts with the workflow task editor 250 to define a set of analytics UIs that enable users, such as the user 208, to execute workflow tasks during runtime. In some examples, the workflow task editor 250 provides a set of templates and a wizard that enables the developer 210 to create an analytics UI for a workflow task. In some examples, the workflow task editor 250 enables the developer 210 to drag-and-drop analytics UI controls into an analytics UI. In some examples, the workflow task editor 250 generates metadata that is executable to generate the analytics UI, including one or more analytics UI controls, for display to users during runtime. Accordingly, and as described in further detail herein, the application studio 206 enables no code/low code development of analytics UIs. That is, the developer 210 can have little to no experience in software development, but still be able to design analytics UIs for runtime generation.

In further detail, the workflow task editor 250 can provide a list of templates that are available for the developer 210 to select from. In some examples, each template corresponds to a type of analytics UI that can be generated. An example type of analytics UI can include, without limitation, an analytics page. In some examples, the type of analytics UI can include one or more sub-types. An example sub-type can include, without limitation, a prediction analytics UI (e.g., an analytics UI configured to display one or more inference results (prediction data)). In some examples, in response to selection of a type (and/or sub-type) of analytics UI, the workflow task editor 250 can provide a set of input fields to receive input from the developer 210. For example, and without limitation, in response to the developer 210 selecting a page template, the workflow task editor 250 can display a text input element requesting the developer 210 to input a caption for the page (e.g., Predictive Impact of New CapEx Request).

In some examples, the workflow task editor 250 automatically provides a metadata file (e.g., in Javascript Object Notation (JSON) format) that is populated with initial metadata (e.g., “_Type”: “Page”, “Caption”: “Predictive Impact of New CapEx Request”). As described in further detail herein, as the developer 210 makes further selections, the metadata file is automatically populated with additional metadata.

In some implementations, the workflow task editor 250 can display a set of analytics UI controls that can be selected for inclusion in the analytics UI. In some examples, the set of analytics UI controls is provided as a text-based list of analytics UI controls, each analytics UI control being associated with a text description (e.g., chart, table, sectioned table). In some examples, the set of analytics UI controls is provided as a set of graphical representations, each graphical representation depicting an analytics UI control. In some examples, the developer 210 can select an analytics UI control from the set of analytics UI controls for inclusion in the analytics UI. For example, drag-and-drop functionality can be provided that enables the developer 210 to click on an analytics UI control, drag the analytics UI control to the analytics UI and un-click (drop) the analytics UI control in the analytics UI.

In some examples, in response to an analytics UI control being selected for inclusion in the analytics UI, the workflow task editor 250 automatically populates that metadata with additional metadata descriptive of the analytics control UI. For example, and without limitation, in response to the developer 210 selecting a sectioned table, the workflow task editor 250 adds metadata to the metadata file, which is descriptive of the sectioned table (e.g., “Controls”:, “_Type”: “Control.Type.SectionedTable”, “_Name”: “SectionedTable”). In some examples, in response to selection of an analytics UI control, the workflow task editor 250 can provide a set of input fields to receive input from the developer 210. For example, and without limitation, in response to the developer 210 selecting a sectioned table the workflow task editor 250 can request that the developer 210 provide input to indicate what is to be included in a section. Continuing with the example above, the developer 210 can indicate that a chart is to be displayed in a section and can provide a caption for the chart (e.g., Impact on Revenue). In response, the workflow task editor 250 can add metadata to the metadata file (e.g., “Sections”:, “_Type”: “Section.Type.ChartContent”, “Header”:, “Caption”: “Impact on Revenue”).

In some examples, each analytics UI control can be associated with a set of features requiring input from the developer 210. The workflow task editor 250 can query the developer 210 to provide input for each of the features. Continuing with the example above, the workflow task editor 250 can query the developer 210 for one or more of a title of the chart, a sub-title of the chart, a description of where the data displayed in the chart is from, a type of chart (e.g., user-selectable from a list of chart types), a size of the chart, titles for each series displayed in the chart, a data source for populating the chart, and the like. In response, the workflow task editor 250 can add metadata to the metadata file (e.g., “ChartContent”:, “Title”: “Revenue”, “Subtitle”: “For Next Fiscal Year {Year}”, “StatusText”: “Prediction by ML”, “ChartView”:, “ChartType”: “Bar”, “ChartHeight”: 650).

In accordance with implementations of the present disclosure, the analytics UI provides output generated by one or more ML models. In some examples, the ML models explorer 254 of the application studio 206 provides a catalog of intelligent data services 204, each providing ML functionality using one or more ML models. For example, the ML models explorer 254 can provide a list of different types of ML models that are available for consumption in workflow tasks. Example ML models can include, without limitation, a time series prediction ML model (e.g., executed by the time series predictions service 236), a similarity scoring ML model (e.g., executed by the similarity scoring service 238), a recommendations ML model (e.g., executed by the recommendations service 240). In some examples, for each ML model, the ML models explorer 254 can provide a description of the ML model. For example, the ML models explorer 254 can provide a textual description of the ML model, input that the ML model receives, output that the ML model provides, a date that the ML model was last trained, an accuracy of the ML model, and the like.

For example, a first ML model can be provided and described as a CapEx revenue impact model that receives input representative of a CapEx request (e.g., type, region/country, description, CapEx amount, any associated operating expenses (OpEx), an estimated internal rate of return (IRR), an estimated return on investment (ROI), a currency) and provides an inference result (predictive data) that is a prediction of an impact that the CapEx request would have over a pre-defined period of time (e.g., annual impact per quarter). In some examples, the first model can also provide a prediction of a result, if the CapEx request were not approved. As another example, a second ML model can be provided and can be described as a CapEx request similarity model that receives input of a CapEx request and provides an inference result that identifies one or more previously submitted CapEx requests that are determined to be sufficiently similar to the CapEx request. In some examples, the previously submitted CapEx requests can include CapEx requests that were approved, which would enable a user to investigate how well that CapEx request ended up performing. In some examples, the previously submitted CapEx requests can include CapEx requests that were denied, which would enable a user to investigate reasons for denial.

In some implementations, a ML model can be associated with an analytics UI control. In the above example of a sectioned table, the ML model can be associated with the sectioned table such that, an output of the ML model (predictive data) is used to populate the section table (e.g., the bar chart). In this manner, the ML model is bound to the analytics UI control. Accordingly, in response to selection of a ML model, the workflow task editor 250 can automatically add metadata to the metadata file, which binds the ML model to the analytics UI control (e.g., “Target” “EntitySet”: “RevenueCollection”,“Service”: “/MDKApp/Services/Data.service”, “QueryOptions”: “$expand=Revenues&$orderby=Quarter”).

In some examples, the workflow task editor 250 queries the developer 210 until all information required for a selected analytics UI control and ML model bound thereto has been input. In response to completing all required selections, the workflow task editor 250 provides a metadata file that is executable in the workflow tasks systems 202. For example, the metadata file is exported to the metadata store 226 of the workflow tasks systems 202. Below is an example of metadata generated by design-time components running in application studio and stored in a metadata file:

```
{
  “_Type”: “Page”,
  “_Name”: “PredictionSectionPage”,
  “Caption”: “Predictive Impact of New CapEx Request”,
  “Controls”: [
    {
      “_Type”: “Control.Type.SectionedTable”,
      “_Name”: “SectionedTable”,
      “Sections”: [
        {
          “_Type”: “Section.Type.ChartContent”,
          “Header”: {
            “Caption”: “Impact on Revenue”
          },
          “ChartContent”: {
            “Title”: “Revenue”,
            “Subtitle”: “For Next Fiscal Year {Year}”,
            “StatusText”: “Prediction by ML”,
            “ChartView”: {
              “ChartType”: “Bar”,
              “ChartHeight”: 650,
              “SeriesTitles”: [
                “With Existing CapEx Only”,
                “Plus New CapEx Request”
              ],
              “Target”: {
                “EntitySet”: “RevenueCollection”,
                “Service”: “/MDKApp/Services/Data.service”,
                “QueryOptions”:
“$expand=Revenues&$orderby=Quarter”
              },
              “CategoryTitles”: “{Quarter}”,
              “CategoryAxisTitle”: “Quarters”,
              “ValueAxisTitle”: “Revenue”,
            “SummaryView”: {
              “SeriesTitles”: [
                “Revenue”,
                “Revenue (Impacted)”
              ],
              “AggregateItem”: {
                “Title”: “Total Revenue”,
                “Value”: {
                  “LeadingUnit”: “$”,
                  “Metrics”: [
                    “{TotalRevenue}”,
                    “{TotalRevenueImpacted}”
                  ]
                }
              }
            }
          }
        }
```

### Listing 1: Example Metadata for Analytics UI

In the example of Listing 1, an analytics control section is depicted with data binding with a backend data service containing revenue predictive data powered by ML. The ML model integrated with the analytics UI control is defined during design-time by a low-code/no-code developer (e.g., the developer 210) using the application studio 206. In this manner, the developer 210 need not build the ML model from scratch and can, instead, select one or more (pre-trained) ML models that are already available in data intelligent services 204 (e.g., hosted on a cloud platform). In some implementations, the developer 210 can request re-training of a particular ML model in a so-called bring your own data (BYOD) paradigm. For example, the developer 210 can select a ML model and provide training data and, in response, the training service 230 can train the ML model using the training data. In this manner, a trained ML model can be provided without requiring professional knowledge of artificial intelligence (AI) and ML on the part the developer 210.

For runtime, the metadata file is deployed to the workflow tasks system 202 for consumption by the user 208. In some examples, the metadata file is parsed by the multi-experience runtime engine 224 to generate platform-native analytics UI controls that run on specific platform to provide a native interactive experience on different devices with various form factors and multiple touchpoints. To achieve this metadata-driven, cross-platform functionality, the multi-experience runtime engine 224 is implemented for each platform, with platform-specific native technology (e.g., Swift on iOS, Java/Kotlin on Android).

More particularly, the multi-experience runtime engine 224 processes the metadata to provide the analytics UI control(s) defined therein. In some examples, the metadata is provided in JSON format, which contains objects as an unordered set of name/value pairs, and an array an ordered collection of values. Objects and arrays are hierarchically organized in a JSON file. In the metadata of the present disclosure, every analytics UI control is defined as a JSON object. The multi-experience runtime engine 224 parses the metadata file, retrieves the JSON object, gets the definition of each analytics UI control, and calls respective operating system APIs to render the control on different runtime environments to get the native user interface and experience (i.e., device-specific). In some examples, predictive data is retrieved from the data intelligent services 204 to populate the analytics UI control. For example, an inference request is transmitted to the data intelligent services 204 through the predictive data adapter 222. In some examples, the inference request indicates the ML model(s) (or service) that the metadata is bound to and indicates data that is to be input to the ML model(s) for inference (e.g., data representative of a CapEx request). The predictive data adapter 222 receives an inference response, which includes inferences (predictive data) provided by the ML model(s). The inferences are used to populated the analytics UI control.

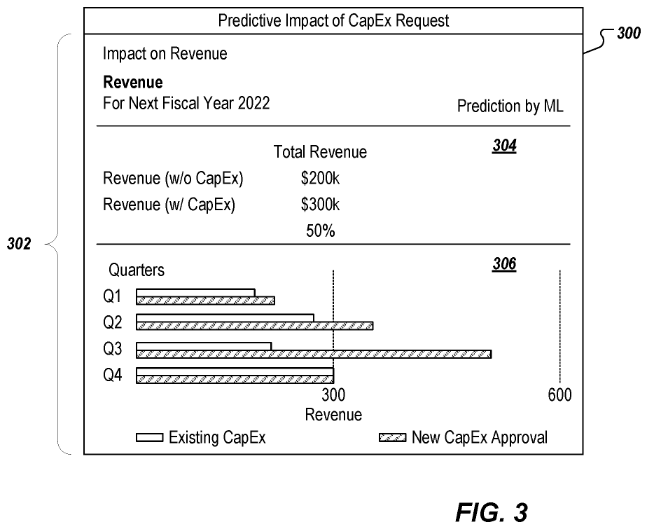

FIG. 3 depicts an example analytics UI 300 that can be provided in accordance with implementations of the present disclosure. The example analytics UI 300 of FIG. 3 correspond to the metadata of Listing 1, above. More particularly, the analytics UI 300 of FIG. 3 includes an analytics UI control 302 provided as a sectioned table that includes a table of inference results 304 and a graph of inference results 306. In the example of FIG. 3, the inference results include a prediction of revenue for a next fiscal year without a CapEx request being approved and a prediction of revenue for the next fiscal year with the CapEx request being approved. In some examples, in response to a user (e.g., the user 208) selecting the analytics UI 300 for display, an inference request is transmitted to a data intelligence service, which includes data representative of the CapEx request as input to a ML model, and inference results are returned to populate the analytics UI 300.

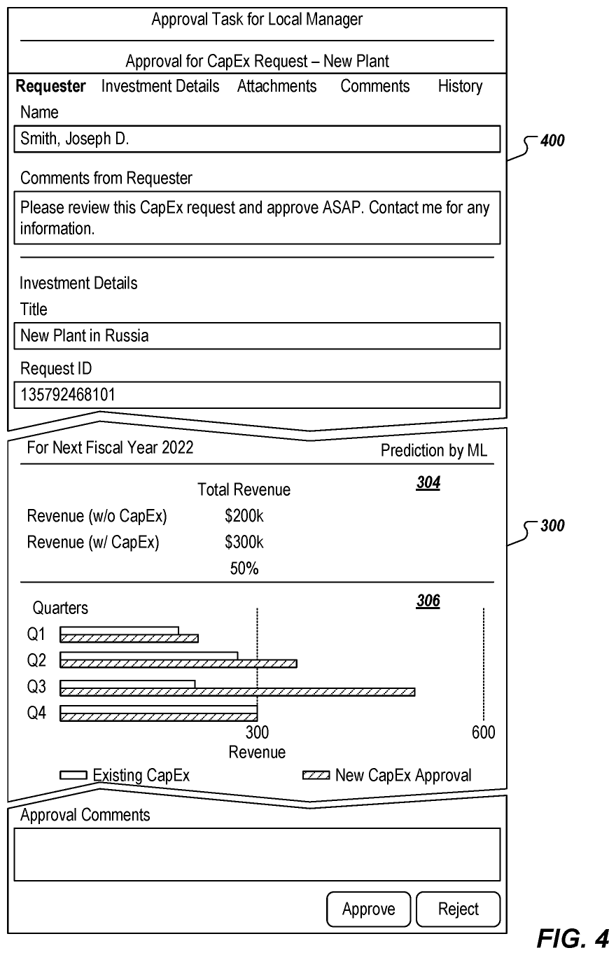

In accordance with implementations of the present disclosure, and as described herein, the analytics UI and analytics UI controls provided therein can be further embedded into a workflow task UI. FIG. 4 depicts another example workflow task UI 400 that can be provided in accordance with implementations of the present disclosure. In the example of FIG. 4, the example analytics UI 300 of FIG. 3 is embedded within the workflow task UI 400, which enables an approver to review the details of a CapEx request and approve or reject the request. With the additional data provided from the ML models and displayed in the analytics UI 300 the approver has more data and better context for determining whether to approve or reject the particular CapEx request.

In some examples, the developer 210 can select a workflow task UI for display in the application studio 206, then drag-drop an analytics UI to where the developer 210 would like it placed within the workflow task UI. The application studio 206 automatically merges the metadata of the analytics UI with pre-existing metadata of the workflow task UI.

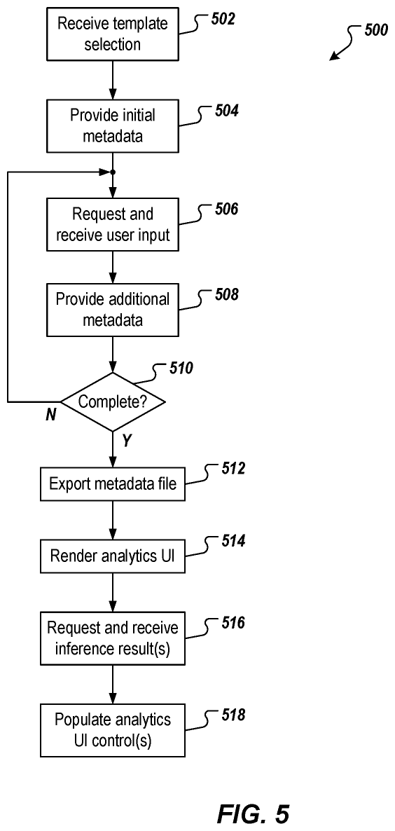

FIG. 5 depicts an example process 500 that can be executed in accordance with implementations of the present disclosure. In some examples, the example process 500 is provided using one or more computer-executable programs executed by one or more computing devices.

A template selection is received (502). For example, and as described herein with reference to FIG. 2, the developer 210 can interact with the application studio 206 to provide an analytics UI in accordance with implementations of the present disclosure. In some examples, the developer 210 can select a template from a set of templates to begin defining an analytics UI. Initial metadata is provided (504). For example, and as described herein, in response to user selection of a template, initial metadata is provided. With reference to the example above, the workflow task editor 250 automatically provides a metadata file (e.g., in Javascript Object Notation (JSON) format) that is populated with initial metadata (e.g., “_Type”: “Page”, “Caption”: “Predictive Impact of New CapEx Request”).

User input is requested and received (506) and additional metadata is provided (508). For example, and as described herein, user input may be required to complete the template and/or portions of the template selected by the developer 210. With reference to the example above, in response to an analytics UI control being selected for inclusion in the analytics UI, the workflow task editor 250 automatically populates that metadata with additional metadata descriptive of the analytics control UI. For example, and without limitation, in response to the developer 210 selecting a sectioned table, the workflow task editor 250 adds metadata to the metadata file, which is descriptive of the sectioned table (e.g., “Controls”:, “_Type”: “Control.Type.SectionedTable”, “_Name”: “SectionedTable”). In some examples, in response to selection of an analytics UI control, the workflow task editor 250 can provide a set of input fields to receive input from the developer 210. For example, and without limitation, in response to the developer 210 selecting a sectioned table the workflow task editor 250 can request that the developer 210 provide input to indicate what is to be included in a section.

It is determined whether the analytics UI is complete (510). For example, and as described herein, it can be determined whether each portion of the metadata is complete or whether additional information is required to complete the metadata. For example, it can be determined that the developer 210 has not provided input for series titles within a chart that is to be displayed and, in response, the developer 210 is prompted to provide input descriptive of the series titles. If it is determined that the analytics UI is not complete, the example process 500 loops back. If it is determined that the analytics UI is complete, a metadata file is exported (512). For example, and as described herein, in response to completing all required selections, the workflow task editor 250 provides a metadata file that is executable in the workflow tasks systems 202. For example, the metadata file is exported to the metadata store 226 of the workflow tasks systems 202.

An analytics UI is rendered (514). For example, and as described herein, the user 208 can engage with the workflow task system 202 to execute one or more workflow tasks. In some examples, in response to the user 208 selecting a workflow task to execute, an analytics UI corresponding to the workflow task is rendered. One or more inference results are requested and received (516). For example, and as described herein, if the analytics UI is bound to a data intelligent service, one or more inference requests are transmitted to the data intelligent service through the predictive data adapter 222 and corresponding inference results are received. One or more analytics UI controls are populated with the one or more inference results (518). For example, and as described herein, ana analytics UI control is populated with the one or more inference results for display to the user 208 within the analytics UI.

As described herein, implementations of the present disclosure provide multiple advantages. For example, implementations of the present disclosure provide holistic real-time information, simulation, and prediction powered by ML models for execution of workflow tasks. In this manner, users are provided with comprehensive information that enables users to complete workflow tasks in a time- and resource-efficient manner. That is, for example, the user does not need to resort to other channels of gathering information for execution of workflow tasks, which would not only take time, but expend technical resources (e.g., processors, memory) in gathering such information. Thus, not only is execution of the workflow task faster and more efficient, expending technical resources is avoided.

As another example, implementations of the present disclosure enable low-code/no-code development to more quickly and efficiently provide analytics Uls for production (runtime). For example, non-expert developers (e.g., developers with no or little coding experience) can easily and quickly design analytics Uls for workflow tasks with a few clicks on the wizard, drag-and-drop functionality to canvas, and browse and select on pane. It is an ideal solution to deal with the explosive demands of development requirement during enterprise digitalization. Further, technical efficiencies are achieved in that processor- and memory-heavy integrated development environments (IDEs) can be foregone.

As still another example, implementations of the present disclosure enable non-expert users (e.g., developers with no or little ML experience) to harnesses the power of ML. For example, implementations of the present disclosure leverage available data intelligent services to adopt cutting-edge ML technology. Normal users without profound AI professional knowledge are able to apply ML technology by reusing, re-training, and deploying out-of-the-box ML models. The inference results provided by the ML models enable a next level of detail and context to be available to users in execution of workflow tasks. As another example, implementations of the present disclosure provide a single source of truth of information for workflow tasks in real-time. That is, instead of manually retrieving historical information from different systems, holistic real-time information is available for users in the workflow task UIs. As still another example, analytics UIs are written once without coding and can be executed on any appropriate platform (e.g., OS/device). That is, the same metadata (generated by no code development) runs across multiple platforms with specific runtime engine to provide native user experiences. As yet another example, modular metadata can be updated separately with better performance. That is, for example, the analytics UI is a separate metadata module from the workflow task UI, which can be separately and incrementally updated by pushing new metadata (analytics UI only) from the application studio 206 to the metadata store 226 of multiple, disparate devices.

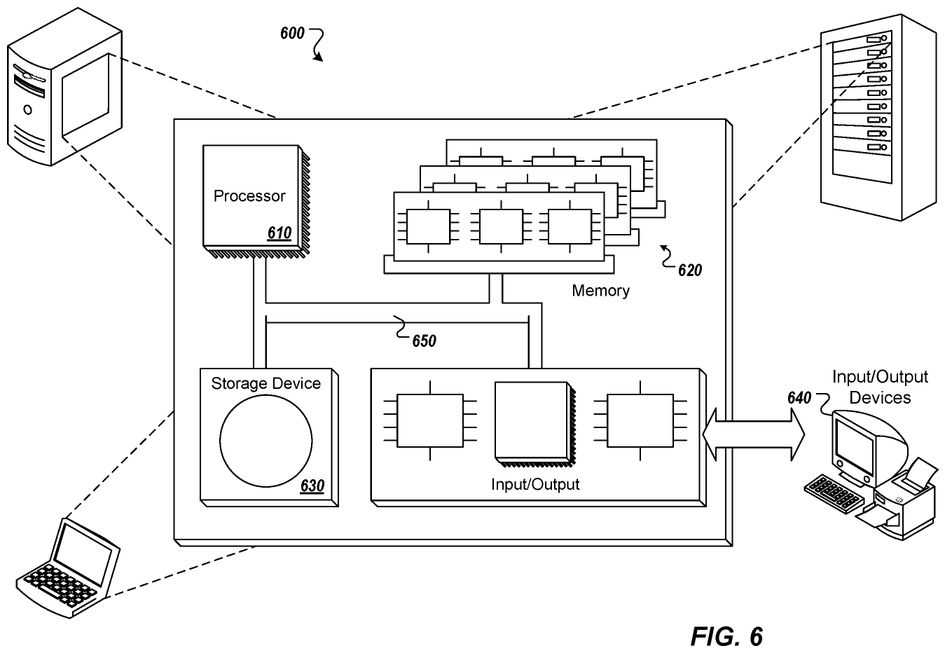

Referring now to FIG. 6, a schematic diagram of an example computing system 600 is provided. The system 600 can be used for the operations described in association with the implementations described herein. For example, the system 600 may be included in any or all of the server components discussed herein. The system 600 includes a processor 610, a memory 620, a storage device 630, and an input/output device 640. The components 610, 620, 630, 640 are interconnected using a system bus 650. The processor 610 is capable of processing instructions for execution within the system 600. In some implementations, the processor 610 is a single-threaded processor. In some implementations, the processor 610 is a multi-threaded processor. The processor 610 is capable of processing instructions stored in the memory 620 or on the storage device 630 to display graphical information for a user interface on the input/output device 640.

The memory 620 stores information within the system 600. In some implementations, the memory 620 is a computer-readable medium. In some implementations, the memory 620 is a volatile memory unit. In some implementations, the memory 620 is a non-volatile memory unit. The storage device 630 is capable of providing mass storage for the system 600. In some implementations, the storage device 630 is a computer-readable medium. In some implementations, the storage device 630 may be a floppy disk device, a hard disk device, an optical disk device, or a tape device. The input/output device 640 provides input/output operations for the system 600. In some implementations, the input/output device 640 includes a keyboard and/or pointing device. In some implementations, the input/output device 640 includes a display unit for displaying graphical user interfaces.

The features described can be implemented in digital electronic circuitry, or in computer hardware, firmware, software, or in combinations of them. The apparatus can be implemented in a computer program product tangibly embodied in an information carrier (e.g., in a machine-readable storage device, for execution by a programmable processor), and method steps can be performed by a programmable processor executing a program of instructions to perform functions of the described implementations by operating on input data and generating output. The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. Elements of a computer can include a processor for executing instructions and one or more memories for storing instructions and data. Generally, a computer can also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASIC s (application-specific integrated circuits).

To provide for interaction with a user, the features can be implemented on a computer having a display device such as a CRT (cathode ray tube) or LCD (liquid crystal display) monitor for displaying information to the user and a keyboard and a pointing device such as a mouse or a trackball by which the user can provide input to the computer.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, for example, a LAN, a WAN, and the computers and networks forming the Internet.

The computer system can include clients and servers. A client and server are generally remote from each other and typically interact through a network, such as the described one. The relationship of client and server arises by virtue of computer programs running on the respective computers and having a client-server relationship to each other.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

A number of implementations of the present disclosure have been described. Nevertheless, it will be understood that various modifications may be made without departing from the spirit and scope of the present disclosure. Accordingly, other implementations are within the scope of the following claims.

What is claimed is:

1. A computer-implemented method for execution of workflow tasks in digital workplaces using one or more analytics user interfaces (Uls), the method being executed by one or more processors and comprising:
extracting, by a multi-experience runtime engine and from a metadata file, metadata that is descriptive of an analytics UI for display on a display of a computing device, the metadata comprising instructions for a binding to a service providing inference using one or more machine learning (ML) models;
in response to the binding, transmitting an inference request to the service through a predictive data adapter, the inference request comprising data representative of a workflow task that is to be executed in a digital workplace;
receiving inference results that are responsive to the inference request; and
displaying, within the analytics UI, the inference results and at least a portion of the data representative of the workflow task.

2. The method of claim 1, further comprising automatically providing at least a portion of the metadata by an application studio in response to one or more selections of a developer interacting with the application studio.

3. The method of claim 1, wherein at least a portion of the metadata comprises user input to an application studio that generates the metadata file.

4. The method of claim 1, wherein the metadata file is partially generated by developer selection of a template from a set of templates.

5. The method of claim 1, wherein the service is bound to the metadata file through user selection of one or more of the service and the ML model from a set of ML models within an application studio that generates the metadata file.

6. The method of claim 1, wherein the analytics UI is integrated into a workflow tasks UI that enables the user to execute a respective workflow task.

7. The method of claim 1, wherein the multi-experience runtime engine extracts the metadata from the metadata file to render the analytics UI native to an operating system of the computing device.

8. A non-transitory computer-readable storage medium coupled to one or more processors and having instructions stored thereon which, when executed by the one or more processors, cause the one or more processors to perform operations for execution of workflow tasks in digital workplaces using one or more analytics user interfaces (UIs), the operations comprising:
extracting, by a multi-experience runtime engine and from a metadata file, metadata that is descriptive of an analytics UI for display on a display of a computing device, the metadata comprising instructions for a binding to a service providing inference using one or more machine learning (ML) models;
in response to the binding, transmitting an inference request to the service through a predictive data adapter, the inference request comprising data representative of a workflow task that is to be executed in a digital workplace;
receiving inference results that are responsive to the inference request; and
displaying, within the analytics UI, the inference results and at least a portion of the data representative of the workflow task.

9. The non-transitory computer-readable storage medium of claim 8, wherein operations further comprise automatically providing at least a portion of the metadata by an application studio in response to one or more selections of a developer interacting with the application studio.

10. The non-transitory computer-readable storage medium of claim 8, wherein at least a portion of the metadata comprises user input to an application studio that generates the metadata file.

11. The non-transitory computer-readable storage medium of claim 8, wherein the metadata file is partially generated by developer selection of a template from a set of templates.

12. The non-transitory computer-readable storage medium of claim 8, wherein the service is bound to the metadata file through user selection of one or more of the service and the ML model from a set of ML models within an application studio that generates the metadata file.

13. The non-transitory computer-readable storage medium of claim 8, wherein the analytics UI is integrated into a workflow tasks UI that enables the user to execute a respective workflow task.

14. The non-transitory computer-readable storage medium of claim 8, wherein the multi-experience runtime engine extracts the metadata from the metadata file to render the analytics UI native to an operating system of the computing device.

15. A system, comprising:
a computing device; and
a computer-readable storage device coupled to the computing device and having instructions stored thereon which, when executed by the computing device, cause the computing device to perform operations for execution of workflow tasks in digital workplaces using one or more analytics user interfaces (UIs), the operations comprising:
extracting, by a multi-experience runtime engine and from a metadata file, metadata that is descriptive of an analytics UI for display on a display of a computing device, the metadata comprising instructions for a binding to a service providing inference using one or more machine learning (ML) models;
in response to the binding, transmitting an inference request to the service through a predictive data adapter, the inference request comprising data representative of a workflow task that is to be executed in a digital workplace;
receiving inference results that are responsive to the inference request; and
displaying, within the analytics UI, the inference results and at least a portion of the data representative of the workflow task.

16. The system of claim 15, wherein operations further comprise automatically providing at least a portion of the metadata by an application studio in response to one or more selections of a developer interacting with the application studio.

17. The system of claim 15, wherein at least a portion of the metadata comprises user input to an application studio that generates the metadata file.

18. The system of claim 15, wherein the metadata file is partially generated by developer selection of a template from a set of templates.

19. The system of claim 15, wherein the service is bound to the metadata file through user selection of one or more of the service and the ML model from a set of ML models within an application studio that generates the metadata file.

20. The system of claim 15, wherein the analytics UI is integrated into a workflow tasks UI that enables the user to execute a respective workflow task.
